(19) United States
(12) Patent Application Publication
(10) Pub. No.: US 2020/0102235 A1
(43) Pub. Date: Apr. 2, 2020

(54) WASTEWATER TREATMENT CONTROL

(71) Applicant: Aerzen USA Corporation, Coatesville, PA (US)

(72) Inventors: Gregory J. Duffy, Telford, PA (US); Eric R. Bennett, West Chester, PA (US)

(21) Appl. No.: 16/146,265

(22) Filed: Sep. 28, 2018

(51) Int. Cl. C02F 3/00

(52) U.S. Cl. CPC C02F 3/006; C02F 2209/006; C02F 2209/08; C02F 2209/22

(57) ABSTRACT

A concentration of dissolved oxygen (DO) can be controlled in accordance with a non-linear approach rate. Further, a target rate of approach can be controlled over time as the setpoint of a controller, such that the controller determines an actual rate of approach, and controls oxygen delivery based on the difference between the actual rate of approach and the target rate of approach using self-tuning mechanisms to improve control response quality.

### BACKGROUND

Wastewater treatment generally refers to a process for converting wastewater into an effluent that can be directly reused or that can be safely returned to the water cycle. Wastewater treatment facilities perform wastewater treatment so as to remove or break down pollutants in municipal wastewater. Wastewater treatment facilities typically include primary, secondary, and tertiary treatment systems. The primary system separates heavier solids from lighter materials. The wastewater that results from the processing at the primary system is introduced into the secondary system. In the secondary treatment system, organic compounds are converted into carbon dioxide, water, and biosolids. During secondary treatment, oxidation reduces the biochemical oxygen demand of wastewater, and may reduce the toxicity of some impurities. The effluent from the secondary treatment system can be further treated in the tertiary treatment system so that it is suitable for discharge into the environment, for example by denitrification.

The biological processes for treating wastewater, for example during secondary treatment, often involve some form of an energy-consuming apparatus that introduces oxygen-containing gas into the wastewater. For example, in a secondary treatment system, the effluent from the primary treatment system can be introduced in an aeration basin, and oxygen can be added to the aeration basin to support bacterial activity. Electrical motors, for example, can consume significant amounts of energy so as to power agitators, compressors, blowers, or the like, to distribute oxygen-containing gas in one or more tanks or basins containing wastewater. To control energy costs associated with distributing oxygen-containing gas, and to control the quality of treatment of the wastewater, secondary treatment systems can implement automated control of the flow of oxygen-containing gas in a given tank.

The need to control the flow of oxygen to the secondary treatment process stems from the need to provide the microbes present in the mixed liquor with the oxygen required to perform metabolic processes, which result in the removal of target chemical species from the mixed liquor. Once stable microbe concentrations in the mixed liquor have been established, the rate of this biologically facilitated breakdown of nutrients or pollutants in the mixed liquor is impacted primarily by the concentration of chemical species to be broken down and the dissolved oxygen (DO) residual. Facilities in most cases have little to no control over the mass or hydraulic loading of nutrients in their influent streams resulting in a non-steady state dynamic process, which requires that the facility either respond in real time to these changing demands or over-treat in order to maintain sufficient nutrient removal and minimum effluent quality. For the purposes of reducing a facility's carbon footprint and energy utilization rate, among other reasons, facilities often elect to control the flow of oxygen their processes. To control the flow of oxygen, levels of dissolved oxygen can be measured in the wastewater in the tank.

In some cases, gas flow is automatically reduced if the measured amount of DO exceeds a target, which is typically referred to as a setpoint. Similarly, gas flow can be increased if the measured amount of DO falls below the setpoint. Further, oxygen requirements of the process can change as a result of various factors. By way of example, changes inloading and changes in flows (e.g., as a result of diurnal changes or storm events) can cause the required DO to change. Failing to match the oxygen requirements of the process can result in costly excess energy consumption and degradation in the quality of the biological process, among other issues.

It is recognized herein that existing approaches to controlling oxygen delivery for treating wastewater, for instance by targeting a DO setpoint, lack efficiencies and precision.

### SUMMARY

As described above, it is recognized herein that existing approaches to controlling oxygen delivery for treating wastewater lack efficiencies and precision. In an example embodiment, a concentration of DO can be controlled in accordance with a non-linear approach rate. Further, a target rate of approach can be controlled over time as the setpoint of a controller, such that the controller determines an actual rate of approach, and controls oxygen delivery based on the difference between the actual rate of approach and the target rate of approach. The target rate of approach can define a rate at which a measured concentration of DO is increased or decreased over time until the measured concentration of DO is equivalent to a target concentration of DO. The target rate of approach can decay as the difference between the measured concentration of DO and the target concentration of DO approaches zero, thereby resulting in a gentle approach to the target DO concentration. In some cases, the approach rate may be capped at a maximum value that can be determined based on mass transfer limitations of the given aeration control system.

In another example, a control system can be configured to control a concentration of dissolved oxygen in a wastewater facility's secondary treatment basin. The control system can determine a target concentration of dissolved oxygen in the secondary treatment basin. The control system can determine a target rate of approach, wherein the target rate of approach defines a rate at which a measured concentration of dissolved oxygen is increased or decreased until the measured concentration of dissolved oxygen is equivalent to the target concentration of dissolved oxygen. The control system can measure and determine a rate of approach of the dissolved oxygen. The control system can further tune a gain value so as adjust an operation of a controller until 1) the measured rate of approach intersects the target rate of approach within a predetermined time period, and 2) the measured concentration of dissolved oxygen is within a predetermined threshold of the target concentration of dissolved oxygen for the predetermined time period. The controller can be configured to modulate airflow in the secondary treatment basin, such that tuning the gain value results in a change to the airflow in the secondary basin. For example, the controller can be configured to receive the gain value from the conditional gain tuner, and to modulate airflow in the secondary treatment basin in accordance with the gain value, such that tuning the gain value results in a change to how airflow rates to the secondary treatment basin are determined.

The foregoing summarizes only a few aspects of the present disclosure and is not intended to be reflective of the full scope of the present disclosure. Additional features and advantages of the disclosure are set forth in the following description, may be apparent from the description, or may be learned by practicing the invention. Moreover, both the foregoing summary and following detailed description are exemplary and explanatory and are intended to provide further explanation of the disclosure.

### BRIEF DESCRIPTION OF THE DRAWINGS

The foregoing summary, as well as the following detailed description of example embodiments of the present disclosure, will be better understood when read in conjunction with the appended drawings. For the purposes of illustrating the example embodiments of the present disclosure, references to the drawings are made. It should be understood, however, that the application is not limited to the precise arrangements and instrumentalities shown.

FIG. 1 depicts a method that can be performed by control system in accordance with an example embodiment.

FIG. 2 is a block diagram of an aeration control unit that be part of the control system in accordance with an example embodiment.

FIG. 3 is a system diagram of an example aeration control system for an aeration basin, within which the aeration control unit can be implemented in accordance with an example embodiment.

FIG. 4 is another system diagram of the aeration control system, showing example blowers that the aeration control unit can control in accordance with an example embodiment.

FIG. 5 is yet another system diagram of the aeration control system in which the aeration control unit can be implemented, in accordance with an example embodiment.

FIG. 6A is a graph that shows example dissolved oxygen (DO) values over time at a start-up of the control system.

FIG. 6B is a tuning graph that shows the response of the control system at the start-up depicted in FIG. 6A.

FIG. 7A is a graph that shows example DO values during an upset to the influent loading strength of the aeration basin, wherein the upset represents a sharp increase to the biological oxygen demand (BOD).

FIG. 7B is a tuning graph that shows the response of the control system during the upset depicted in FIG. 7A.

FIG. 8A is a graph that shows example DO values during an upset to the influent strength of the aeration basin, wherein the upset represents a sharp decrease to the BOD.

FIG. 8B is a tuning graph that shows the response of the control system during the upset depicted in FIG. 8A.

### DETAILED DESCRIPTION OF ILLUSTRATIVE EMBODIMENTS

As described above, it is recognized herein that existing approaches to controlling oxygen delivery for treating wastewater lack efficiencies and precision. In particular, for example, existing controllers often rely on Proportional Integral Derivative (PID) feedback control mechanisms that require system tuning to operate in a satisfactory manner. These control mechanisms can manage simple 1^{st} order non-time lag steady state systems. It is recognized herein, however, that that they are often incapable of controlling high order time lagged non-linear dynamic systems to a high degree of performance. Such systems can include secondary treatment systems in which conditions deviate from the conditions experienced at the time of tuning/commissioning. Results of such a mechanism (e.g., PID controls) employed in dynamic systems (such as those described above and herein) can include the system being overtuned and unstable for portions of the day, or the system being detuned to the point that it can no longer respond to dynamic influent loading conditions. It is recognized herein that either performance (overtuning or detuning) can result in a similar loss of controllability, which ultimately can compromise effluent quality and energy efficient operations. Other existing control mechanisms employed include those which utilize biological and mass transfer model based equations to inform control efforts. These control mechanisms require model calibration to maintain accuracy and provide a complex control solution for complex processes. These systems require specialized engineering experts to maintain and deploy and demand premium hardware for the mathematical processing of the developed models, which subsequently increases the price of this solution. Additionally, it is recognized herein that the models contained therein frequently require calibration, are sensitive to changes in bioactivity, and are frequently provided as ‘black box’ solutions to end users who otherwise have a desire to maintain and understand their processes. By way of yet another example, there are control solutions that propose to directly measure the oxygen uptake rate of the bioreactor using off-gas analyzers to determine the amount of gas airflow required to maintain system homeostasis. These controllers propose the addition of expensive and difficult to maintain off-gas analyzers to a hazardous environment, which operators otherwise generally seek to avoid for health and sanitary reasons. The initial capital expenditure and maintenance costs of keeping these sensitive devices online and operational has for the most part prevented this control mechanism from becoming commonplace in the industry.

In view of the above-described technical problems and shortcomings associated with existing control systems, technical solutions are described herein that include a control methodology that directly accommodates the process's challenges (e.g., nonlinear process dynamics, time lag, non-steady state operation) while addressing the adaptability, cost, robustness, and open source platform pain points mentioned above. In an example embodiment, a concentration of DO can be controlled in accordance with a non-linear approach rate. Further, a target rate of approach can be controlled over time as the setpoint of a controller, such that the controller determines an actual rate of approach, and controls oxygen delivery based on the difference between the actual rate of approach and the target rate of approach. The target rate of approach can define a rate at which a measured concentration of DO is increased or decreased over time until the measured concentration of DO meets a target concentration of DO. The target rate of approach can decay as the difference between the measured concentration of DO and the target concentration of DO approaches zero, thereby resulting in a gentle approach to the target DO concentration. In an example, the target rate of approach is determined based on a primary process variable, a user-defined setpoint, and a process appropriate time constant that defines a reasonable expected rate of DO change per time (for each mg/L deviation from setpoint). In some cases, the approach rate may be capped at a maximum value that can be determined based on mass transfer limitations of the given aeration control system.

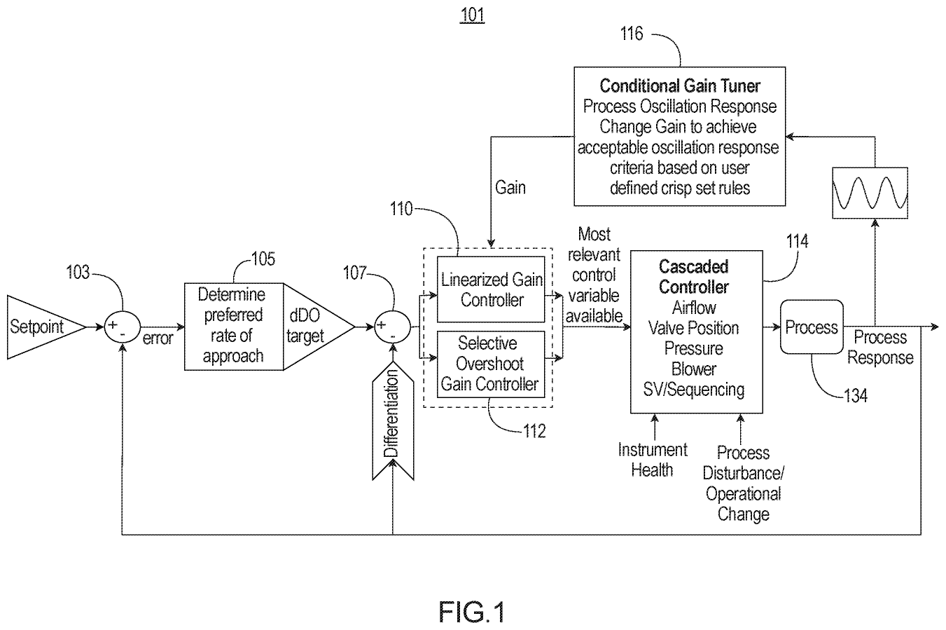

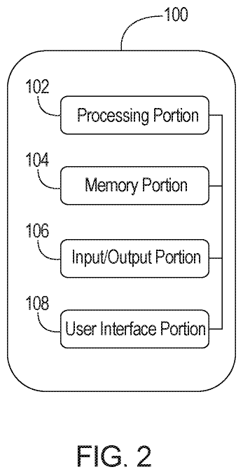

Referring initially to FIGS. 1 and 2, a controller 100, which can also be referred to as an aeration control unit 100, can control the rate that a concentration of DO changes over time. Examples are described herein in which the aeration control unit 100 controls the rate at which a concentration of DO changes over time in a secondary wastewater treatment basin, but it will be understood that the aeration control unit 100 can control the rate at which a concentration of DO changes over time in any tank or basin as desired. It will further be understood that embodiments are not limited to the examples described herein, and therefore the aeration control unit 100 can be configured to control other chemical processes as desired.

Referring particularly to FIG. 2, in an example configuration, the controller 100 includes a processing portion 102, a memory portion 104, an input/output portion 106, and a user interface (UI) portion 108. It is emphasized that the block diagram depiction of the aeration control unit 100 is exemplary and not intended to imply a specific implementation and/or configuration. The processing portion 102, memory portion 104, input/output portion 106, and user interface portion 108 can be coupled together to allow communications there between. As should be appreciated, any of the above components can be distributed across one or more separate devices and/or locations. In an example, referring also to FIG. 1, the aeration control unit 100 can include a linearized gain controller 110, a selective overshoot controller 112 cascaded controller 114, and a conditional gain tuner 116. In another example, the controller 100 can include the linearized gain controller 110 and the selective overshoot controller 112, and can be communicatively coupled to the conditional gain tuner 116 and the cascaded controller 114. The input/output portion 106 can be configured so that equipment can be accessed via EtherNet 3 g, 4 g, LTE for data monitoring and/or remote support modification purposes. Thus, the controller 100 and the control system 118 can be communicatively coupled to remote nodes or entities, for example, for remote data monitoring and remote support/modification purposes, though it will be understood that the control system 118 can be communicatively coupled to remote enities for alternative purposes as desired.

In various embodiments, the input/output portion 106 includes a receiver of the aeration control unit 100, a transmitter of the aeration control unit 100, or a combination thereof The input/output portion 106 is capable of receiving and/or providing information pertaining to a given control system, such as a control system 118, which can be an aeration control system 118. The input/output portion 106 can communicate with various nodes or peripheral devices within the control system 118. For example, the controller 100 can send control signals or instructions to peripheral devices so as to adjust performance of the control system 118. Similarly, the controller 100 can receive measurements or data from peripheral devices, which the controller 100 can process to generate control signals and instructions. As should be appreciated, transmit and receive functionality may also be provided by one or more devices external to the controller 100.

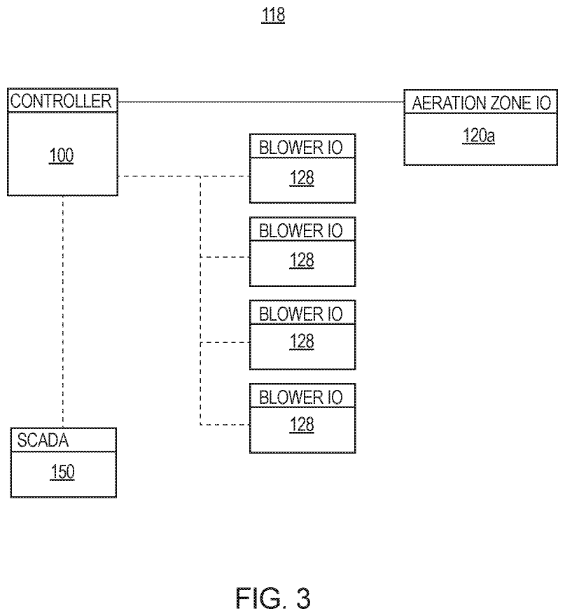

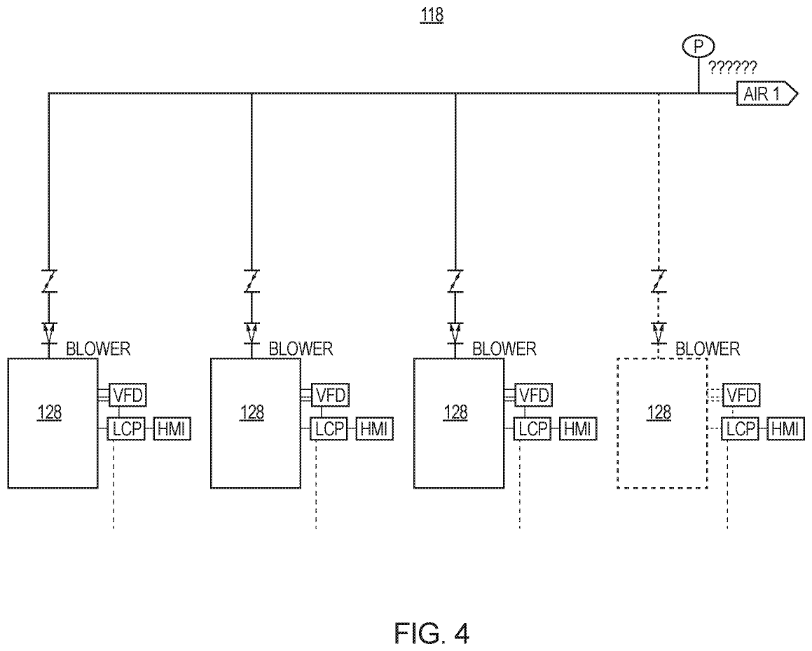

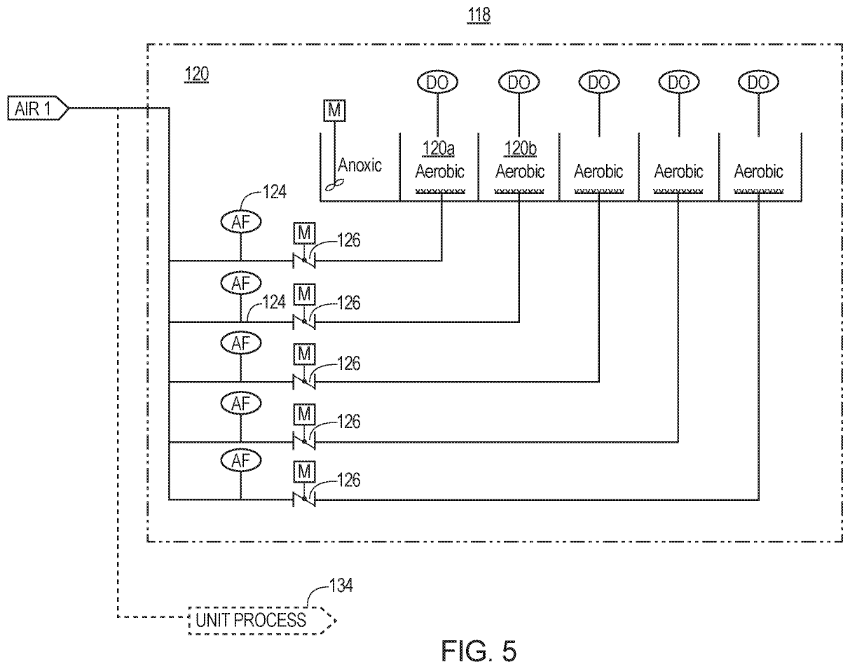

Referring to FIGS. 3-5, it will be understood that FIGS. 3-5 depict one example of a suitable architecture in which the controller 100, for instance the conditional gain tuner 116, can be implemented, it being appreciated that numerous suitable alternative architectures are envisioned. That is, the control system 118 is presented for purposes of example, and the controller 100 can operate within alternative control systems as desired. As shown, the control system 118 can be implemented to control oxygen delivery or DO in a tank or aeration basin 120. The basin 120 can be configured as a secondary treatment basin for wastewater. The basin 120 can define one or more zones, for instance a first zone 122a and a second zone 122b, which define locations within the basin 120. It will be understood that the basin 120 can be divided into any number of zones as desired. The basin 120 can include one or more inlets for entry of wastewater to be aerated in the basin. The basin 120 can include one or more outlets for discharge of effluent.

Various nodes or peripheral devices of the control system 118 can be communicatively coupled to the controller 100. The nodes or peripheral devices can include, for example and without limitation, one or more air flow (AF) sensors 124, one or more automated control valves 126, and one or more blowers 128. Referring in particular to FIG. 3, data from the blowers 128 can be relayed to the controller 100 via hardwired analog or discrete, or Ethernet/serial protocols. The controller 100 can further be communicatively coupled to a supervisory control and data acquisition (SCADA) or similar type system 150 that includes software and hardware elements configured to control industrial process locally or at remote locations. The controller 100 can receive data from various aeration zones, for instance aeration zone 122a. Such data can include, by way of example and without limitation, DO values, positions of valves 126, airflow data from airflow sensors 124, and pressure data.

Referring again to FIG. 2, depending upon the exact configuration and type of processor, the memory portion 104 can be volatile (such as some types of RAM), non-volatile (such as ROM, flash memory, etc.), or a combination thereof. In an example, the memory portion 104 can include a 64M SSRAM memory. The controller 100 can include additional storage (e.g., removable storage and/or non-removable storage) including, but not limited to, tape, flash memory, smart cards, CD-ROM, digital versatile disks (DVD) or other optical storage, magnetic cassettes, magnetic tape, magnetic disk storage or other magnetic storage devices, universal serial bus (USB) compatible memory, or any other medium which can be used to store information and which can be accessed by the aeration control unit 100.

The controller 100, and thus the conditional gain tuner 116, also can contain the user interface portion 108 allowing a user to communicate with the controller 100. The aeration control unit 100 can include inputs that provide the ability to control the aeration control unit 100, via, for example, buttons, soft keys, a mouse, voice actuated controls, a touch screen, or the like. By way of example, a user can use the user interface 108 to configure the aeration control unit 100 for the wastewater treatment facility, and in particular the aeration control system, in which it is implemented. Thus, the controller 100 can be configured with various rates of change setpoints. As used herein, unless otherwise specified, a target rate of change and a rate of change setpoint can be used interchangeably, without limitation. Similarly, as used herein, unless otherwise specified, rate of change and an approach rate can be used interchangeably, without limitation. The user interface portion 108 can provide outputs, including visual information (e.g., via a display), audio information (e.g., via speaker), mechanically (e.g., via a vibrating mechanism), or a combination thereof. In various configurations, the user interface portion 108 can include a display, a touch screen, a keyboard, or any combination thereof. The user interface portion 108 can further include any suitable device for inputting biometric information, such as, for example, fingerprint information, retinal information, voice information, and/or facial characteristic information. Thus, the controller 100 can include a processor, a memory, and communication circuitry. The controller 100 can be configured to connect via the communication circuitry to a plurality of nodes or peripheral devices (e.g., air flow sensors 124, automated control valves 126, blowers 128) in an aeration control system for a wastewater treatment basin. The controller 100, and thus the control system 118, can further include computer-executable instructions stored in the memory of the controller 100 and the control system 118 which, when executed by the processor of the controller 100, cause the controller 100, and thus the control system 118, to perform operations, such as the operations described with reference to FIG. 1.

The conditional gain tuner 116, and thus the controller 100, can include one or more logic devices that interpret values associated with one or more parameters of biological processes so as to establish control values. The control system 118 can include one or more mechanical devices (e.g., control valves 126 and blowers 128) and one or more electrical devices (e.g., sensors 124). The controller 100 can include software or code to interpret data related to process conditions that can be gathered by measurement devices (e.g., sensors 124) so as to establish control values. The controller 100 can be a specialized unit having sufficient computing capacity. For example, the controller 100 can include, or accommodate, proportional, proportional-integral (PI), and proportional-integral-derivative (PID) controllers. As further described below, the controller 100, in particular the conditional gain tuner 116, can be configured to tune the control system 118 and process data, control values, and control signals.

Referring now to FIG. 1 in particular, an example control method 101 for modulating DO to a particular rate of approach setpoint in the aeration basin 120 is shown. In particular, as shown, mass air flow is adjusted so as to control oxygen delivery and modulate a rate of change of DO to the rate of approach setpoint. Control methods are performed at 110 and 112. The control methods performed at 110 and 112 can benefit from the tuning that occurs at 116, which is described in detail herein. It will be understood that the tuning at 116 can be modified so as suit the control of other process alternative to those described herein. By way of example, the linearized gain control at 110 might not be necessary for a linear process. Similarly, the selective overshoot gain control at 112 might not be necessary for fast responding systems for which overshoot is not a major concern. It will be understood that the example method 101 can be implemented with different parameters by the controller 100 to control other process variables of the aeration control system 118, for instance airflow/valve position, airflow or pressure/blower speed, effluent ammonia, or the like. As an initial matter, the following variables can used in the example control method 101:
DO, generally refers to the final control variable, such as the concentration of a chemical species dissolved in the process. In this example, it represents the concentration of dissolved oxygen.
ΔDO, generally represents the difference between the user-defined setpoint and the actual process reading. In this example, ΔDO represents the difference between the target concentration of dissolved oxygen (DO) and the actual (measured) concentration of DO. The terms actual and measured can be used interchangeably herein, without limitation, unless otherwise specified.
μ_{Base}, represents a base approach rate for each point of ΔDO. A point can refer to 1 mg/L residual DO in mixed liquor. Mixed liquor refers to the mixture of settled wastewater and activated sludge in a given aeration basin, although mixed liquor and wastewater can be used interchangeably herein, unless otherwise specified. The approach rate can refer to the rate that the actual DO concentration changes over time so as to arrive at or deviate from (within a threshold) the final target concentration of DO or residual DO.

$$\frac{dDO}{{dT}_{Target}} ,$$

refers to a preferred rate of approach. In this example, it represents the target rate of approach, which defines a rate at which a measured concentration of DO is increased or decreased over time until the measured amount of DO is substantially equivalent (within a threshold) to the target concentration of DO. The

$$\frac{dDO}{{dT}_{Target}}$$

can represent a range of values having a minimum and maximum. The minimum and maximum can be set by a user of the aeration control unit 100, for example, based on the properties of the wastewater treatment facility in which the aeration control unit 100 controls. In various examples, the

$$\frac{dDO}{{dT}_{Target}}$$

produces a natural and gradual pathway to convergence with the DO setpoint, for example, by accommodating intrinsic process dynamics. An example target rate of approach as a function of time (t) can be approximated in shape by a classical 1^{st} order response with time lag to a step perturbation, where species concentration (c) can be represented by: c(t)=1−exp(−t/T), where T=5 minutes.

With continuing reference to FIG. 1, at 103, the controller 100, and thus the control system 118, can determine the ΔDO. For example, the controller can first identify or determine a final target concentration of DO (or residual DO) in wastewater (or mixed liquor) that is in the wastewater treatment basin. In an example, the target concentration of DO can be referred to as the DO setpoint (DOₛₑₜₚₒᵢₙₜ. The DOₛₑₜₚₒᵢₙₜ can be input by a user of the aeration control unit 100 via the user interface 108, for example, based on operational characteristics of the wastewater treatment basin. The controller 100 can receive the actual concentration of DO in the wastewater from one or more peripheral devices that measure values. For example, the actual concentration of DO can be part of the control process response 134. As used herein, actual and measured can be used interchangeably without limitation, unless otherwise specified. The actual concentration of DO can be represented by DO_{current}. Thus, the controller 100 can determine the difference between the target concentration of dissolved oxygen (DO) and the actual concentration of DO, at 103, according to equation (1):

ΔDO:=DOₛₑₜₚₒᵢₙₜ−DO_{current} (1)

With continuing reference to FIG. 1, at 105, the controller 100 can determine the target rate of approach setpoint according to equation (2):

$$\frac{dDO}{{dT}_{Target}} := {μ}_{Base} \cdot Δ DO \qquad ( 2 )$$

In equation (2), μ_{Base} can be determined based on an initial estimation. The variable μ can represent a gain value, and can vary based on the wastewater treatment basin for which the aeration control unit 100 controls. The variable μ_{Base} can be akin to a time constant. For example, setting μ_{Base} to 0.25/ minute means that for every point of DO missing, the goal is to achieve an approach rate of 0.25 mg/L*min. In some cases, the higher μ_{Base} is set, the steeper and more pronounced the approach rate is toward the final DO setpoint. Thus, a lower number for μ_{Base} can represent a more gradual approach toward the final DO setpoint. The μ_{Base} can be approximated prior to commissioning a treatment system, based on experience for example, and can be tuned on-site to reflect the natural speed to which a process responds to a step change in setpoint. By way of example, a value of 3 for μ_{Base} might be unreasonable because that means it is asking for the process to change at a rate of +3 mg/L*minute if it were 1 mg/L under setpoint. That would result in a steep approach that would generally cause process instability and overshoot.

At 107, the control system identifies the actual rate of approach, and can determine the input to 110 and 112 as the difference between the actual rate of approach

$$( \frac{dDO}{dT} )$$

and the target rate of approach as:

$$( Δ \frac{dDO}{dT} )$$

$$\frac{dDO}{{dT}_{Target}} - \frac{dDO}{dT} \qquad ( 3 )$$

Turning now to gain parameter determination, it is recognized herein that gains do not change in typical control theory. In accordance with an example embodiment, however, the conditional gain tuner 116 can tune a gain value (θ) and change the gain value such that it defines a self-tuning floating point gain value. For example, if the actual concentration of DO

and the actual rate of change of DO

$$( \frac{dDO}{dT} )$$

have intersected their setpoints

$$( {DO}_{Setpoint} and \frac{dDO}{{dT}_{Target}} , respectively )$$

during a predetermined time period, the aeration control system 118 can be considered to be in oscillation. In some cases, the time period x is determined as the shortest time period by which a complete (or substantially complete) step response has occurred. The time for a step response to occur can be determined by observing the system's time delay to step changes. In particular, the time that it takes a given wastewater treatment system to reach equilibrium after a step change is made to a control value position or airflow rate is the time delay. Thus, time period x can be selected so as to allow for ample time to elapse so that the control process response 134 can reach a new equilibrium after a change in setpoint. The time period x can be multiplied by a factor, such as a factor greater than 1, for instance a factor from 1 to 5, to allow for multiple (corresponding to the factor) control actions to take place between an expected collision or intersection with a setpoint. By way of example, if a process takes 60 seconds to reach equilibrium after a step response, a value of 3 minutes (3*60 seconds) may be chosen for the time period x so as to account for 3 control actions. It will be understood that the time period x may vary as desired.

In an example embodiment, when at least one intersection criterion is met, the system is considered to be in oscillation. An example intersection criterion is when, during the predetermined time x, the actual rate of change of DO increases from a rate that is less than the target rate of change of DO to a rate that is greater than the target rate of change of DO. Another example intersection criterion is when, during the predetermined time x, the actual rate of change of DO decreases from a rate that is greater than the target rate of change of DO to a rate that is less than the target rate of change of DO. When the system is in oscillation, tuning of the gain value, for instance by the conditional gain tuner 116, may continue. In an example, the conditional gain tuner 116 can tune the gain value so as to adjust operation of a controller (e.g., the linearized gain controller at 110 and the selective overshoot gain controller 112). Continuing with the example, the controller can be configured to tune a gain value, such that the controller is able to modulate airflow in the secondary treatment basin in a modified manner. For example, the controller 100 can be configured to receive the gain value from the conditional gain tuner 116, and to modulate airflow in the secondary treatment basin in accordance with the gain value, such that tuning the gain value results in a change to how airflow rates to the secondary treatment basin are determined.

In some cases, when at least one intersection criterion is met and at least one deadband criterion is met for a predetermined period of time, the system is considered stable. An example deadband criterion is when, throughout the predetermined time period x, the actual DO is within its deadband that defines a maximum acceptable value above the DO setpoint and a minimum value below the DO setpoint. Thus, gain value can be tuned so as to adjust an operation of a controller until 1) the measured rate of approach intersects the target rate of approach within a predetermined time period, and 2) the measured concentration of dissolved oxygen is within the predetermined threshold of the target concertation of dissolved oxygen for the predetermined time period. The DO setpoint can define the middle of the deadband. In particular, an example deadband criterion is when, throughout the predetermined time period x, the actual DO is less than a maximum target value of DO, and is greater than a minimum target value of DO. The maximum target value of DO can define an acceptable threshold or value that is greater than the DO setpoint, and the minimum target value of DO can define an acceptable threshold or value that is less than the DO setpoint. Thus, the deadband can define a maximum acceptable target value of DO and a minimum acceptable target value of DO. In an example, if no tuning criteria are met, the system is considered detuned. In some cases, when the system is considered stable, tuning actions cease.

By way of another example, if the actual rate of change of DO at a first time is less than the target rate of change of DO at the first time, then x seconds passes so as to define a second time, and the actual rate of change of DO at a given time between the first time and second time is greater than the target rate of change of DO at the given time, the actual rate of change of DO has intersected its setpoint during the predetermined time period x. Thus, continuing with the example, the aeration control system 118, in particular the control process response 134, is in oscillation. As another example, if the actual concentration of DO and the actual rate of change of DO do not intersect their respective setpoints during the predetermined time period x, the aeration control system 118, in particular the control process response 134, is considered non-oscillatory or under-tuned. If a given zone (e.g., zone 122a) is in oscillation and the actual rate of change of DO for the given zone is within a predetermined concentration y mg/L for another predetermined time period z, the tuning of the aeration control unit 100, and thus the control process response 134, is considered stable. The predetermined concentration y can define the maximum acceptable threshold or value above the target rate of change

$$\frac{dDO}{{dT}_{Target}} ,$$

and the predetermined concentration y can define the minimum acceptable threshold or value below the target rate of change of DO. Thus, the target rate of change of DO

$$( \frac{dDO}{{dT}_{Target}} )$$

and the predetermined concentration y can define a tuning band, within which the aeration control unit is considered to be in a stable state.

It will be understood that the above-described variables x, y, and z can be selected as desired. For example, the variables can be based on a reasonable response time for a given process. A reasonable response time may refer to the shortest time by which a process responds to a control step change so as to arrive at an equilibrium, multiplied by a factor to allow for a number of step changes that is equivalent to the factor.

A given system, for instance the aeration control system 118, can achieve stable control through a manner of different pathways. In an example pathway, the system is in a detuned state, then is in an oscillating state until it reaches a stable state. In an example, the aeration control system 118 is considered to be in a stable state when systems pass from detuned, to oscillating, to stable, however any conditions observed which result in stable and long lasting control action where the DO setpoint is being held will be considered ‘stable’ and deactivate the tuning mechanism at 116.

Thus, as described above and without being bound by theory, a goal of the controller 100, and thus the control system, is to have both the DO and rate of change of DO values (signals) intersect their respective setpoints during a predetermined time. Another goal of the controller 100, and thus the control system, is to have the rate of change of DO intersect its setpoint during a predetermined time, and have the DO remain within its deadband during the predetermined time. In an example, the controller 100 controls DO within a deadband, but does not use a deadband for rate of change of DO, so that the rate of approach may be truly oscillating while the actual DO is adequately close to the DO setpoint (e.g., less 0.05 mg/L from setpoint), so as to produce stable conditions. Thus, another goal of the controller 100 is to achieve DO measurements that fall within the deadband of the DO setpoint for predetermined period of time, which may be user-defined.

Referring again to FIG. 1, the conditional gain tuner 116 can determine whether a given zone, and thus the respective control process response 134, is in oscillation, based on whether the actual concentration of DO and the actual rate of change of DO intersects their respective setpoints within a predetermined time period, as described above. Further, the conditional gain tuner 116 can determine whether the control process response from 134, and thus the tuning of the controller 100, is stable, based on whether the actual rate of change of the DO is within the tuning band and based on whether the actual DO is within its deadband.

If the conditional gain tuner 116 determines that a given zone is non-oscillatory, the gain parameter θ can be increased so as to define an increased gain value. The operation of the controller 100 (e.g., at 110 and 112) can thus be adjusted in accordance with the increased gain value. The gain parameter θ, which can also be referred to herein as simply the gain or the gain value, without limitation, can be increased when a tuning time or value expires. The gain value can be increased according to a step size. The tuning time and the step size can be configured by a user of the control system 118. The step size and tuning time can determine how fast the gain parameter can be changed. In example, a given wastewater treatment facility can be modeled to respond to the control actions described herein, so as to select a step size and tuning time that results in only slight (if any) tuning on-site. In an example, the default step size is 0.1 and the default tuning time is 1 second, as it is recognized herein that those values can provide an adequate tuning response given typical process dynamics. It will be understood that the step size and tuning time can vary as desired.

Similarly, if the conditional gain tuner 116 determines that a given zone is oscillatory and unstable, the gain parameter θ can be decreased so as to define a decreased gain value. The operation of the controller 100 (e.g., at 110 and 112) can thus be adjusted in accordance with the decreased gain value. The gain parameter can be decreased upon the expiration of the predetermined time. The gain parameter can be decreased according to a step size, which can be a constant and can be equivalent to the step size used to increase the gain parameter. In an alternative example, the step size can decay as the actual concentration of DO approaches the DO setpoint. In this example, the tuning time can remain constant.

In an example, the conditional gain tuner 116, and thus the aeration control unit 100, does not adjust the gain parameter θ when the control process response 134 is characterized as stable. Thus, tuning can be suspended when the measured rate of approach intersects the target rate of approach within a predetermined time period, and the measured concentration of DO is within the predetermined threshold of the target concentration of DO for the predetermined time period. Through the tuning described above, the system 118 can determine appropriate adjustments to system mass airflow targets as the gain value is used to inform the relationship between airflow and DO. These mass airflow targets can cascade (at 114) through the control method 101 so as to determine airflow production and distribution targets, for example. In an example, because these cascaded systems 114 remain active through the tuning at 116 (and experience their own tuning process), when the system obtains a stable state with respect to DO, it can then be affirmed that the embedded control loops have also reached a degree of stability. Without being bound by theory, this affirmation can be because instability in an embedded control loop may frequently create process perturbations that propagate through to disturb higher level control loops like those governing DO control.

Tuning up (e.g., by increasing the gain value) can occur when a zone is not oscillating or partially oscillating for periods of time during which the actual concentration of DO is not within the acceptable deadband. Tuning may be suspended during periods of time when the absolute values of the second derivative with respect to time (acceleration) for DO (the first derivative with respect to time of the rate of change of DO) is too high, as this indicates a period of flux or rapid system adjustment. This upper threshold value on this second derivative of DO term can be selected by one skilled in the art, familiar with the response dynamics of a given system. Tuning down (e.g., by decreasing the gain value) occurs when the system is oscillating but not in a stable state, for example, as determined by a time period spent inside the DO deadband. In some cases, if the system can be described as stable at any time, the tuning efforts are suspended. Additionally, if the system is up against a naturally occurring system boundary (e.g., oxygen supply or delivery devices have reached their minimum or maximum operational limitations) tuning is suspended.

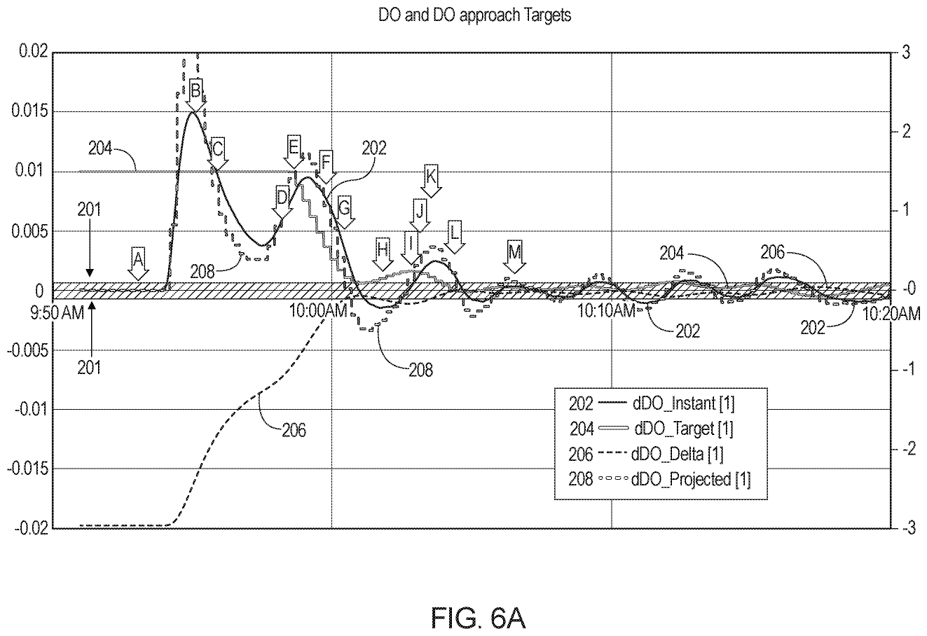

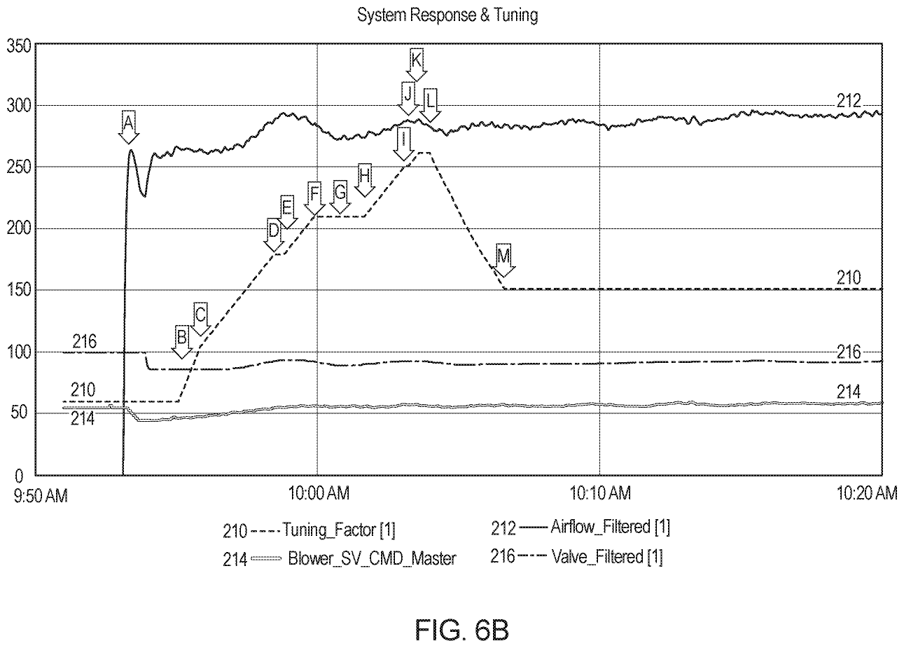

Referring generally to FIGS. 6A, 7A, and 8A, an actual rate of approach of DO 202 is shown over time as compared to the target rate of approach of DO 204 for different example scenarios. The difference between the DO setpoint and actual DO (ΔDO 206) over time is also shown for the different example scenarios. FIGS. 6B, 7B, and 8B depict the system response to the respective targets shown in FIGS. 6A, 7A, and 8B. In particular, the system response includes the gain value θ that can be referred to as the tuning factor 210, an airflow control value 212, a blower control value 214, and a valve control value 216.

Referring in particular to FIGS. 6A and 6B, example startup of the control system 118 depicted. At time A, in accordance with the illustrated example, DO control is turned on, and at least one blower begins operation. Tuning is paused at this time. At time B, the pause period expires, and tuning begins; the system is not in oscillation. The initial tuning factor is high enough to allow for the actual rate of change of DO 202 to intersect the target rate of change of DO 204 at time C. At time C, the actual rate of change of DO 202 intersects the target rate of change of DO 204, and the tuning factor 210 is adjusted to less aggressive tuning. Accordingly, the system is in a partially oscillating state for which tuning up can be necessary because the actual DO exceeds its DO deadband 201. As shown, the system continues to tune until the second derivative of DO exceeds its maximum value (at D), which suspends tuning actions. This condition is relieved (at E) and tuning resumes in accordance with the illustrated example until it is again enacted (at F), resulting in suspension of tuning. When the DO crosses into its control deadband (at G) tuning actions are suspended until actual DO again deviates from its setpoint so that ΔDO 206 is sufficiently large so as to warrant additional tuning (at H). At time H, tuning resumes until time I when tuning is relaxed due to a high second derivative of DO value. Time J indicates a point where tuning resumes, a result of the second derivative of DO (acceleration) falling back within an acceptable range. This tuning continues until point K where DO crosses into its deadband 202. At this point tuning is disabled. Tuning remains disabled until time L, where DO intersects with its setpoint, signaling that the system is oscillating (fully oscillatory). The result of this condition is that detuning begins (at L). Detuning continues until the system proves stable (within deadband 202 for a defined time period) as denoted by point M. At this point system tuning is disabled for the remainder of this example as the system has obtained and manages to maintain a stable designation. Deviation from the DO deadband 202 while maintaining full oscillation can result in a loss of the stable designation, and can result in subsequent detuning. Loss of DO or rate of change DO oscillation and a sufficient deviation from the DO deadband can result in the loss of the full oscillation and stable designation, and thus result in further tuning action.

In some cases, the gain parameter θ can be constrained by a minimum and maximum value. The minimum and maximum values can be user-defined. In an example, the aeration control unit 100 suspends operation of the conditional gain tuner 116, so that the conditional gain tuner 116 is restricted from adjusting the gain parameter θ. By way of example, adjustments to the gain parameter θ can be suspended while the aeration control system 118 is in manual control. As another example, adjustments to the gain parameter θ can be suspended while a component of the aeration control system 118 is operating within a range of a physical operational constraint. For example, adjustments to the gain parameter θ can be suspended when one of the blowers 128 is operating within a range of one of its maximum or minimum speeds, or when one of the valves 126 is within a range of its minimum or maximum position.

Referring again to FIG. 1, the gain parameter θ from the conditional gain tuner 116 can be input into the linearized gain controller 110 and the selective overshoot controller 112, so as to adjust the operation of a controller in accordance with the gain. The linearized gain controller 110 and the selective overshoot controller 112 can also receive values from the control process response 134, such as the difference between the actual rate of approach

$$( \frac{dDO}{dT} )$$

and the target rate of approach

$$( \frac{dDO}{{dT}_{Target}} )$$

computed at 107. The control process response 134 can also include a system response time (τ). In an example, the system response time τ can be determined or characterized by how long it takes for the concentration of DO to change in response to a step change in airflow. Thus, the system response time can refer to a delay, for instance in seconds. Using the system response time τ and a moving average of the second derivative, the control system can determine a feedforward correction factor (β). A projected rate of change of concentration of DO 208 can be determined, in accordance with equation (4):

$$\frac{dDO}{{dT}_{Projected}} := \frac{\overline{( {d}^{2} DO )}}{{dT}^{2}} \cdot τ + \frac{dDO}{dT} \qquad ( 4 )$$

Thus, the projected rate of change can be based on the measured rate of approach, wherein the projected rate of change defines the rate or approach at a future time. The projected rate of change of concentration of DO 208 can be calculated as an input to 112. In an example, the projected rate of change 208 is calculated by extrapolating the current rate of change 202 out 30 seconds. Without being bound by theory, this action can be useful to enable the controller 100 to determine whether it is on the pathway toward oscillation of its setpoint. The projected rate of change 208 can enable the controller 100 to suspend control actions that may contribute to overshoot of the DO setpoint. The projected rate of change 208 can further enable the controller 100 to take action to counter such overshoot in proportion to how large the predicted overshoot is. Thus, air flow can be adjusted in the secondary treatment basin based on the projected rate of change, for example when the projected rate of change indicates that the rate of approach will overshoot the target rate of approach. By way of example, if a system is projected to overshoot its DO setpoint by a large margin in the next 30 seconds, it could be said that the airflow supply to the zone at this time exceeds the process demands as deemed by the controller 100. An appropriate control action at this time may be to reduce the airflow to the zone, even though the actual DO may be currently lower than the DO setpoint.

If the actual rate of change is less than the target rate of change, and the projected rate of change is greater than the target rate of change

$$( \frac{dDO}{dT} < \frac{dDO}{{dT}_{Target}} and \frac{{dDO}_{Projected}}{dT} > \frac{dDO}{{dT}_{Target}} ) ,$$

then the feedforward correction factor can be determined in accordance with equation (5):

$$β := ( \frac{dDO}{{dT}_{Target}} - \frac{dDO}{{dT}_{Projected}} ) \cdot θ \qquad ( 5 )$$

If the rate of change is greater than the target rate of change, and the projected rate of change is less than the target rate of change

$$( \frac{dDO}{dT} > \frac{dDO}{{dT}_{Target}} and \frac{{dDO}_{Projected}}{dT} < \frac{dDO}{{dT}_{Target}} ) ,$$

then the feedforward correction factor can be determined in accodance with equation (6), at 112:

$$β := ( \frac{dDO}{{dT}_{Target}} - \frac{dDO}{{dT}_{Projected}} ) \cdot θ \qquad ( 6 )$$

Equation (6) can represent the calculated control action of 112 under the second set of conditions described above. If the absolute value of the ΔDO is greater than 1, or if the above conditions for equation (5) and equation (6) are not met, then β:=0. The output of 110 and 112 can be added together to produce a single setpoint for the cascaded controller 116, as described below with reference to equation (7).

In accordance with an example, the feedforward correction factor β can be used by the aeration control unit 100 to determine a new control value. By way of example, the aeration control unit 100 can determine a new mass flow rate \dot{m}_{new} using the feedforward correction factor β in accordance with equation (7):

$${\dot{m}}_{new} := {\dot{m}}_{current} + ( \frac{dDO}{{dT}_{Target}} - \frac{dDO}{dT} ) \cdot {α}_{DO} \cdot θ + β \qquad ( 7 )$$

In equation (7), \dot{m}_{current} respresents the actual or measured active mass delivery rate, which can be part of the process response 134. The gain parameter θ, as described above, can be a floating self-tuning gain value computed by the conditional gain tuner 116, and thus the control system 118. The new mass delivery rate \dot{m}_{new} can be constrained between a minimum and maximum value. The minimum and maximum values can be configured by a user of the control system 118. In equation (7), α_{DO} can represent a mass delivery correction factor. The mass delivery correction factor can account for losses in mass transfer efficiency the closer the process variable residual gets to saturation. The mass delivery factor (alpha) can be selected prior to commissioning and can be a dimensionless correction factor of approximately 1. In some cases, the self-tuning mechanism solves around whatever value is chosen here, but alpha can be used to normalize the values of the gain. For example, if a given system was tuning at values between 50 and 200, alpha can be increased so as to bring the values closer to the 0-100 range. In turn, incorporating α_{DO} can assist in linearizing the control process response 134.

The aeration control unit 100 can determine the mass delivery correction factor α_{DO} in accordance with equation (8):

$${α}_{DO} := \frac{{DO}_{sat}}{( {DO}_{sat} - {DO}_{current} )} \qquad ( 8 )$$

In equation (8), DOₛₐₜ can represent the theoretical maximum concentration (or saturation value) of DO, for instance in the aeration basin 120. The DO_{current} can represent the actual or measured concentration of DO, for instance in the aeration basin 120. In an example, αₓ is normalized to one (1). In some cases, the mass delivery correction factor can be limited to the value produced by an actual DO at 50% saturation, which may be representative of a typical operational range) so as to prevent the controller 100 from dividing by zero (0).

Referring again to FIGS. 6A and 6B, an example system start-up is depicted. The system start-up can be a dynamic non-linear event in which large changes in airflow are required to meet DO demands. It is recognized herein that control events at system start-up can deteriorate into instability given a controller tuning that would be acceptable during steady state operation. As shown by the example system response, the controller described herein can provide rapid real-time tuning to keep the control process response 134 from oscillation and instability.

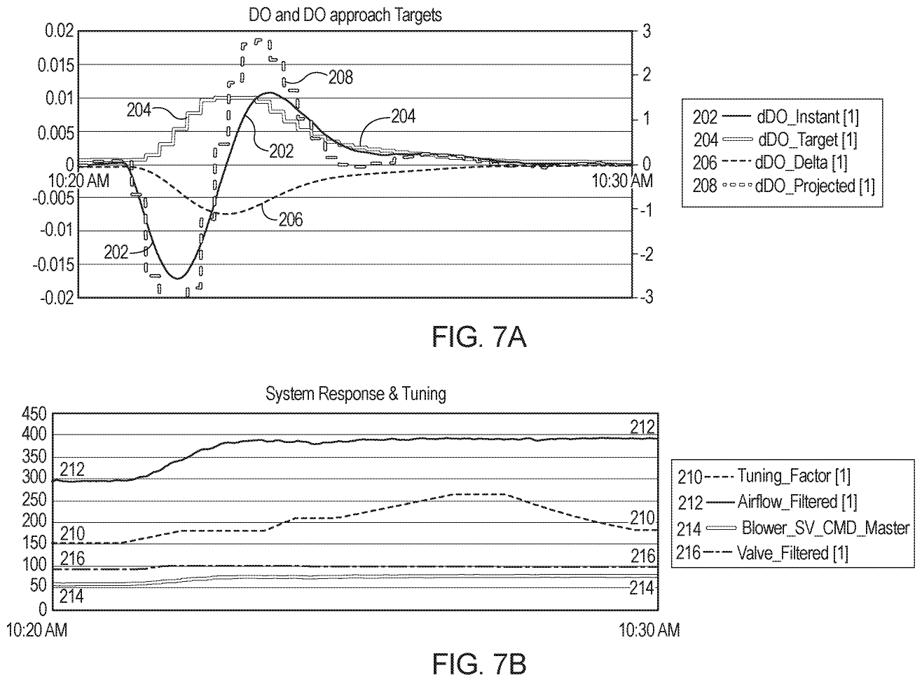

Referring in particular to FIGS. 7A and 7B, an example biological oxygen demand (BOD) spike is depicted. Here, there is an upset to the influent loading strength of the facility (e.g., BOD sharply increases). The result is that the airflow 212 increases to maintain an appropriate concentration of DO. Shift of the BOD from its initial value to its final value affects the oxygen uptake rate (OUR) of the process in a non-linear fashion. Thus, in an example, the controller 100 tunes its gain value to reject the disturbance in a timely manner.

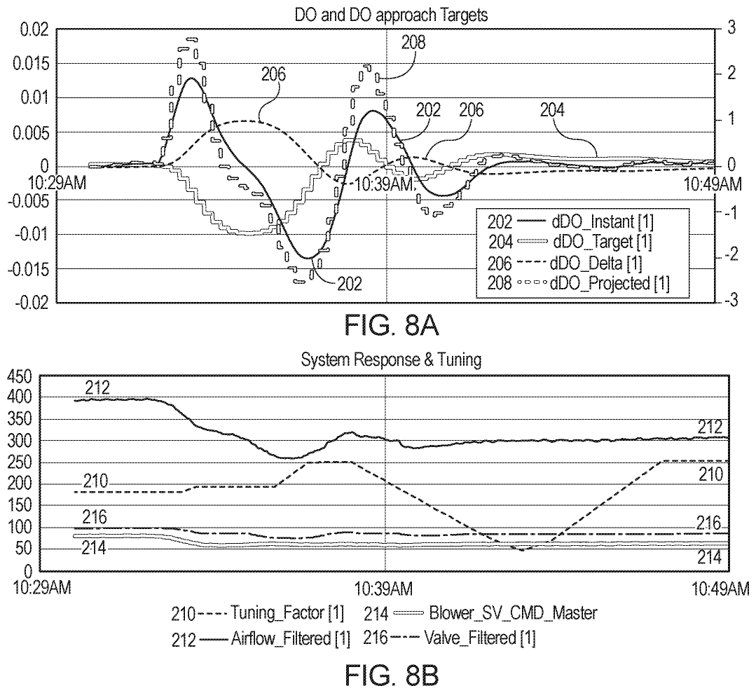

Referring in particular to FIGS. 8A and 8B, an example BOD return is depicted. Here, there is an upset to the influent loading strength of the facility (e.g., BOD sharply drops). Similarly to when the BOD increases sharply as described above, this affects the OUR in a non-linear fashion and sets off an oscillatory response. The controller 100, in particular the conditional gain tuner 116 described herein, can back off the tuning to stabilize the process and reduce oscillation. Then, as shown, the tuning can be tightened to acceptable levels.

It will be understood that any of the methods and processes described herein may be embodied in the form of computer executable instructions (i.e., program code) stored on a computer-readable storage medium which instructions, when executed by a machine, such as a computer, server, aircraft recovery control unit, or the like, perform and/or implement the systems, methods and processes described herein. Specifically, any of the steps, operations or functions described above may be implemented in the form of such computer executable instructions. Computer readable storage media include both volatile and nonvolatile, removable and non-removable media implemented in any method or technology for storage of information, but such computer readable storage media do not includes signals. Computer readable storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other physical medium which can be used to store the desired information and which can be accessed by a computer.

In describing preferred embodiments of the subject matter of the present disclosure, as illustrated in the Figures, specific terminology is employed for the sake of clarity. The claimed subject matter, however, is not intended to be limited to the specific terminology so selected, and it is to be understood that each specific element includes all technical equivalents that operate in a similar manner to accomplish a similar purpose.

This written description uses examples to disclose the invention, including the best mode, and also to enable any person skilled in the art to practice the invention, including making and using any devices or systems and performing any incorporated methods. For example, the control loop 101 can represent an instance that can apply to each DO control zone 118 with no limit. Thus, each zone can have a mass flow controller (e.g., controller 101) that is tuned in accordance with the example method 101. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed:

1. A method for controlling a concentration of dissolved oxygen in a wastewater facility's secondary treatment basin, the method comprising:
determining a target concentration of dissolved oxygen in the secondary treatment basin;
determining a target rate of approach, the target rate of approach defining a rate at which a measured concentration of dissolved oxygen is increased or decreased until the measured concentration of dissolved oxygen is within a predetermined threshold of the target concentration of dissolved oxygen;
measuring a rate of approach of the dissolved oxygen; and
tuning a gain value so as to adjust an operation of a controller until 1) the measured rate of approach intersects the target rate of approach within a predetermined time period, and 2) the measured concentration of dissolved oxygen is within the predetermined threshold of the target concertation of dissolved oxygen for the predetermined time period.

2. The method as recited in claim 1, wherein the controller is configured to modulate airflow in the secondary treatment basin, such that tuning the gain value results in a change to the airflow in the secondary treatment basin.

3. The method as recited in claim 1, wherein tuning the gain value further comprises:
determining whether the measured rate of approach intersects the target rate of approach within the predetermined time period;
if the measured rate of approach does not intersect the target rate of approach within the predetermined time period, increasing a gain value so as to define an increased gain value; and
adjusting the operation of the controller in accordance with the increased gain value.

4. The method as recited in claim 3, wherein the gain value is increased by a step size at a predetermined rate.

5. The method as recited in claim 1, wherein tuning the gain value further comprises:
determining whether the measured rate of approach intersects the target rate of approach within the predetermined time period;
if the measured rate of approach intersects the target rate of approach within the predetermined time period, decreasing the gain value so as to define a decreased gain value; and
adjusting the operation of the controller in accordance with the increased gain value.

6. The method as recited in claim 5, wherein the gain value is decreased by a step size at a predetermined rate.

7. The method as recited in claim 1, wherein tuning the gain value further comprises:
determining whether the measured rate of approach intersects the target rate of approach within the predetermined time period;
determining whether the measured concentration of dissolved oxygen is within the predetermined threshold of the target concentration of dissolved oxygen for the predetermined time period;
if the measured rate of approach intersects the target rate of approach within the predetermined time period, and the measured concentration of dissolved oxygen is not within the predetermined threshold of the target concentration of dissolved oxygen, increasing the gain value so as to define an increased gain value; and
adjusting the operation of the controller in accordance with the increased gain value.

8. The method as recited in claim 1, the method further comprising:
when the measured rate of approach intersects the target rate of approach within a predetermined time period, and the measured concentration of dissolved oxygen is within the predetermined threshold of the target concentration of dissolved oxygen for the predetermined time period, suspending tuning the gain value;
after suspending tuning the gain value, determining that the measured concentration of dissolved oxygen has exited the predetermined threshold of the target concentration of dissolved oxygen for the predetermined time period; and
in response to determining that the measured concentration of dissolved oxygen has exited the predetermined threshold, resuming tuning the gain value.

9. The method as recited in claim 1, the method further comprising:
based on the measured rate of approach, determining a projected rate of approach, wherein the projected rate of approach defines the rate of approach at a future time; and
based on the projected rate of approach, adjusting the air flow in the secondary treatment basin.

10. The method as recited in claim 9, wherein the projected rate of approach indicates that the rate of approach will overshoot the target rate of approach.

11. A control unit comprising a processor, a memory, and communication circuitry, the control unit configured to connect via the communication circuitry to a plurality of nodes in a control system for a wastewater treatment basin, the control unit further comprising computer-executable instructions stored in the memory of the control unit which, when executed by the processor of the control unit, cause the control unit to perform operations comprising:
determining a target concentration of dissolved oxygen in wastewater that is in the wastewater treatment basin;
determining a target rate of approach, the target rate of approach defining a rate at which a measured concentration of dissolved oxygen is increased or decreased over time until the measured concentration of dissolved oxygen meets the target concentration of dissolved oxygen; and
controlling oxygen delivery to the wastewater treatment basin so as to achieve the target rate of approach.

12. The control unit as recited in claim 11, wherein the target rate of approach decays as the difference between the measured concentration of dissolved oxygen and the target concentration of dissolved oxygen approaches zero.

13. A control system configured to monitor and control operations within a secondary treatment basin, the control system comprising a conditional gain tuner and a controller communicatively coupled to the conditional gain tuner, the control system configured to:
determine a target concentration of dissolved oxygen in the secondary treatment basin;
determine a target rate of approach, the target rate of approach defining a rate at which a measured concentration of dissolved oxygen is increased or decreased until the measured concentration of dissolved oxygen is within a predetermined threshold of the target concentration of dissolved oxygen; and
measure a rate of approach of the dissolved oxygen,
wherein the condition tuner is configured to tune a gain value so as to adjust an operation of the controller until 1) the measured rate of approach intersects the target rate of approach within a predetermined time period, and 2) the measured concentration of dissolved oxygen is within the predetermined threshold of the target concertation of dissolved oxygen for the predetermined time period.

14. The control system as recited in claim in claim 13, wherein the controller is configured to receive the gain value from the conditional gain tuner, and to modulate airflow in the secondary treatment basin in accordance with the gain value, such that tuning the gain value results in a change to how airflow rates to the secondary treatment basin are determined.

15. The control system as recited in claim 14, wherein the controller is further configured to control oxygen delivery to the secondary treatment basin so as to achieve the target rate of approach.

16. The control system as recited in claim 13, wherein the target rate of approach decays as the difference between the measured concentration of dissolved oxygen and the target concentration of dissolved oxygen approaches zero.

17. The control system as recited in claim 13, wherein the conditional gain tuner is further configured to:
determine whether the measured rate of approach intersects the target rate of approach within the predetermined time period;
if the measured rate of approach does not intersect the target rate of approach within the predetermined time period, increase a gain value so as to define an increased gain value; and
adjust the operation of the controller in accordance with the increased gain value.

18. The control system as recited in claim 13, wherein the conditional gain tuner is further configured to:
determine whether the measured rate of approach intersects the target rate of approach within the predetermined time period;
if the measured rate of approach intersects the target rate of approach within the predetermined time period, decrease the gain value so as to define a decreased gain value; and
adjust the operation of the controller in accordance with the increased gain value.

19. The control system as recited in claim 13, wherein the conditional gain tuner is further configured to:
determine whether the measured rate of approach intersects the target rate of approach within the predetermined time period;
determine whether the measured concentration of dissolved oxygen is within the predetermined threshold of the target concentration of dissolved oxygen for the predetermined time period;
if the measured rate of approach intersects the target rate of approach within the predetermined time period, and the measured concentration of dissolved oxygen is not within the predetermined threshold of the target concentration of dissolved oxygen, increase the gain value so as to define an increased gain value; and
adjust the operation of the controller in accordance with the increased gain value.

20. The control system as recited in claim 13, wherein the conditional gain tuner is further configured to:
when the measured rate of approach intersects the target rate of approach within a predetermined time period, and the measured concentration of dissolved oxygen is within the predetermined threshold of the target concentration of dissolved oxygen for the predetermined time period, suspend tuning the gain value;
after tuning the gain value is suspended, determine that the measured concentration of dissolved oxygen has exited the predetermined threshold of the target concentration of dissolved oxygen for the predetermined time period; and
in response to determining that the measured concentration of dissolved oxygen has exited the predetermined threshold, resume tuning the gain value.
